(19) United States
(12) Patent Application Publication
(10) Pub. No.: US 2016/0277792 A1
(43) Pub. Date: Sep. 22, 2016

(54) NON-PROTOCOL WIRELESS INTERFACE APPARATUS REGARDLESS OF INTERFACE STANDARDS

(71) Applicant: WiseJet, Inc., Daejeon (KR)

(72) Inventors: InnYeal OH, Daejeon (KR); ByeongNam AHN, Gyeonggi-do (KR); ChulSoon PARK, Daejeon (KR)

(73) Assignee: WiseJet, Inc., Daejeon (KR)

(21) Appl. No.: 14/948,874

(22) Filed: Nov. 23, 2015

(30) Foreign Application Priority Data
Mar. 20, 2015 (KR) 10-2015-0038532

(51) Int. Cl. H04N 21/4363; H04L 5/00; H04N 21/242; H04N 21/4385; H04N 21/436; H04N 21/414; H04N 21/2385; H04W 72/04; H04N 21/43

(52) U.S. Cl. CPC H04N 21/43637; H04W 72/04; H04L 5/0007; H04N 21/242; H04N 21/4302; H04N 21/43615; H04N 21/41407; H04N 21/2385; H04N 21/4385; H04N 21/43635; H04W 84/12

(57) ABSTRACT

Disclosed is a non-protocol wireless interface apparatus for transmitting video and voice signals from a smart device to a display device over a high-speed wireless channel by uncompressed technique without using a complex wireless transport protocol, regardless of interface standards such as MHL or MyDP, etc., wherein the apparatus comprises a first broadband wireless adapter connected to a wired connection terminal of the smart device, and a second broadband wireless adapter connected to a wired connection terminal of the display device.

### CROSS-REFERENCE TO RELATED APPLICATION

This U.S. non-provisional patent application claims priority under 35 U.S.C §119 of Korean Patent Application No. 10-2015-0038532, filed on Mar. 20, 2015, the entire contents of which are hereby incorporated by reference.

### BACKGROUND OF THE INVENTION

1. Field of the Invention

The present invention relates to a non-protocol wireless interface apparatus regardless of interface standards, and more specifically, to a technology for transmitting video and voice signals from a smart player to a display device over a high-speed wireless channel by uncompressed technique without using a complex wireless transport protocol, regardless of interface standards such as MHL or MyDP, etc.

2. Description of the Related Art

An interface capable of integrally transmitting digital video signals and audio signals to a display device without compressing the signals in players such as a computer, a DVD player, a video game console, and the like, which has been developed by electronics companies, is HDMI (high-definition multimedia interface), and an interface which has been developed by PC-related companies against HDMI is DP (display port).

An interface connecting to HDMI in a mobile device, which has been made by the HDMI camp, is MHL (mobile high-definition link), and an interface which has been made by the DP camp is MyDP (mobility display port).

The mobile device is a device in which an operation system is installed, program can be installed therein, and voice and data communications over a communication network are possible. A typical example of the mobile device is smart phones. In order to allow a person to view contents such as high-quality video of a smart phone on a large screen or allow several persons to view and enjoy the contents together, a MHL-to-HDMI cable or a MyDP-to-DP/HDMI cable which connects a MHL port or MyDP port (hereinafter, referred to as “MHL/MyDP”) of a smart phone to a HDMI port of a display device by means of a wire line so as to allow a person to view various contents of the smart phone on a large screen is used.

In the present invention, a device in which under the operation system (OS), applications can be installed and voice or data communications over a communication network are possible is referred to as “smart device.”

A wired connection between a smart device and a display device has disadvantages such as hassle in installation, restriction in utilizing contents, constraints on active regions of a user, etc. Thus, wireless communication apparatuses and wireless communication techniques which can replace the MHL-to-HDMI cable or MyDP-to-HDMI cable have been required.

The first problem of the conventional technology is burdensome setting. For WiFi or WiGig (Wireless Gigabit) (hereinafter, referred to as “WiFi”) channeling, necessary setting is required to interwork transmission and reception after turning WiFi on. If necessary, an application should be installed in a smart phone at the initial stage for interworking, which is a burdensome process. This process is a hard and cumbersome process for a user who is not good at handling a device. Also, the process becomes a factor which causes stress to the user and makes the user hesitate to use the device, thereby decreasing the usage rate.

The second problem is that paring time is required. After setting the smart phone for WiFi channeling, a transmitter and a receiver further need several seconds until a WiFi channel is interworked and set. Furthermore, if channel setting fails or automatic re-setting is executed, a user should wait for more time or initiate the setting again to use, which is burdensome. Whenever using smart phone mirroring, this process becomes a factor which causes a user stress and makes the user hesitate to use, thereby decreasing the usage rate.

The third problem is a limitation of a wireless connection between devices. All smart phones and tablet PCs have a WiFi function, but some display devices which are used as receiving apparatus have no WiFi function. In addition, many cameras and camcorders which can be used as transmitting apparatus also have no WiFi function. Such peripheral device environment has a limitation of a wireless connection between devices, so connectable devices are limited.

The fourth problem is a limitation of the real-time application due to the delay of signals. Due to the limitation of a transmission speed caused by the limitation of the capacity of WiFi channel, in order to transmit high-quality video wirelessly, the video should be compressed and transmitted. In WiGig channel capable of transmitting several gigabits per second, even if compression is not performed, either WiFi channel or WiGig channel goes through a process of packetizing voice video signals in a frame unit by a packetizer and connecting the signals to a WiFi or WiGig protocol stack, in order to load the signals on the protocol stack. The receiver also performs a reverse process to obtain the video and voice signals finally required. Such transmitting and receiving processes lead to a delay in the transmission of signals so make the real-time treatment difficult. The delay causes inconvenience for applications that require the real-time treatment, such as image transmission, etc., which is based on game or automobile stability.

The fifth problem is power consumption of smart phones. The modulation method having a high index, which is used in WiFi, highly requires SNR, and particularly, the OFDM modulation method requires the transmission of relatively high power signals in order to secure linearity, so the method consumes lots of power. This becomes a factor that limits the long-term use for, for example movies, in a smart phone driven by battery, and causes inconvenience to a user.

US Patent Publication No. 2013-0195233 presents a technique for synchronizing for wireless transmission of data wherein a multimedia source device transmits data to a sink device over a wireless channel.

The prior art transmits data according to a transport protocol by compressing or packetizing a signal to be transmitted, as the basic premise. In case of using a WiFi channel, a data packet is included in a protocol adaptation layer and transmitted. In case of using a WiFi channel, due to the limitation of a transmission band, a compression is performed before packetizing the data.

When transmitting the data, the compressed and packetized information should be reached to the receiver and recovered to the information before the compression and the packetization. Thus, in the data communication process, a time delay caused by the compression and packetization is inevitable, so there is a limitation in applications that require the real-time treatment such as video transmission for game or automobile stability. In addition, the complex signaling process becomes a factor that limits the long-term use of a smart device driven by battery.

Taking into account the peripheral device environment, using only a WiFi channel in the wireless connection for transmitting and receiving high-capacity information between devices has a limitation on utilizing various multimedia source devices. Further, in order to transmit video or voice signals, which are high-capacity information, in real time without loss of the information, there is a need to use a broadband high-speed wireless channel having the transmission speed in gigabit unit.

Accordingly, it is required to develop an interface capable of connecting to an output port of various multimedia source devices and transmitting high-capacity information such as video or voice signals to multimedia sink devices such as a display device over a high-speed wireless channel, and relevant high-speed transmission techniques.

### SUMMARY OF THE INVENTION

The object of the present invention, which has been developed according to the aforementioned necessity, is to provide an interface apparatus capable of transmitting video and voice signals from a smart player to a display device over a high-speed wireless channel by uncompressed technique without using a complex wireless transport protocol, regardless of interface standards such as MHL or MyDP, etc.

According to an aspect of the invention to achieve the object described above, there is provided a non-protocol wireless interface apparatus for wirelessly transmitting video data from a smart device to a display device over a single channel, including: a clock signal separation unit for separating a common mode clock signal from a wired connection terminal of the smart device to generate control data; a multiplexer for mixing and multiplexing the video data and the control data; and a first wireless communication unit for wirelessly transmitting the multiplexed data over the single channel, wherein the data signal is wirelessly transmitted over the single channel by uncompressed technique without using a transport protocol, regardless of the interface standard of the smart device.

According to another aspect of the invention to achieve the object described above, there is provided a non-protocol wireless interface apparatus for wirelessly transmitting video data from a smart device to a display device over two channels, including: a clock signal separation unit for separating a common mode clock signal from a wired connection terminal of the smart device to generate control data; a first high-speed wireless communication unit for wirelessly transmitting the video data; and a first low-speed wireless communication unit for wirelessly transmitting the control data, wherein the data signal is wirelessly transmitted over the two channels by uncompressed technique without using a transport protocol, regardless of the interface standard of the smart device.

According to further another aspect of the invention to achieve the object described above, there is provided a non-protocol wireless interface apparatus for wirelessly receiving data signal transmitted from a smart device to a display device over a single channel, including: a second wireless communication unit for wirelessly receiving the data signal over a single channel; a clock data recovery unit for recovering a clock and a data of the data signal received at the second wireless communication unit; a demultiplexer for separating a video data and a control data from the received data signal; and a clock signal mixing unit for mixing the separated video data with a clock signal, wherein the data signal is wirelessly received over the single channel by uncompressed technique without using a transport protocol, regardless of the interface standard of the smart device.

According to further another aspect of the invention to achieve the object described above, there is provided a non-protocol wireless interface apparatus for wirelessly receiving data signal transmitted from a smart device to a display device over two channels, including: a second high-speed wireless communication unit for wirelessly receiving a video data; a second low-speed wireless communication unit for wirelessly receiving a control data; a clock data recovery unit for recovering a clock and a data of the signal received at the second high-speed communication unit; and a clock signal mixing unit for mixing the video data recovered at the clock data recovery unit with a clock signal, wherein the data signal is wirelessly received over the two channels by uncompressed technique without using a transport protocol, regardless of the interface standard of the smart device.

According to further another aspect of the invention to achieve the object described above, it combines the interface apparatus for wirelessly transmitting over the single channel with the interface apparatus for wirelessly receiving over the single channel or it combines the interface apparatus for wirelessly transmitting over the two channels with the interface apparatus for wirelessly receiving over the two channels.

### BRIEF DESCRIPTION OF THE DRAWINGS

The above and other objects, features and advantages of the present invention will be more apparent from the following detailed description taken in conjunction with the accompanying drawings, in which:

FIG. 1 is a conceptual diagram of a non-protocol wireless interface apparatus according to the present invention;

FIG. 2 shows one embodiment for transmitting video and voice data (hereinafter, referred to as “video data”) and control data over a single high-speed wireless channel according to the present invention;

FIG. 3 shows one embodiment for two-channel transmission according to the present invention: transmitting video data over a high-speed wireless channel and transmitting control data over a low-speed wireless channel;

FIG. 4 shows one embodiment for receiving the data wirelessly transmitted over a single channel according to the present invention;

FIG. 5 shows one embodiment for two-channel reception according to the present invention: receiving video data over a high-speed wireless channel and receiving control data over a low-speed wireless channel;

FIG. 6 shows another embodiment according to the present invention, wherein in case where the output port of the smart device is HDMI, a HDMI-to-MHL/MyDP converter is added before the first broadband wireless adaptor; and

FIG. 7 shows further another embodiment according to the present invention where the output port of the smart device is DP.

### DETAILED DESCRIPTION OF THE PREFERRED EMBODIMENTS

Hereinafter, detailed embodiments for implementing the present invention will be explained with referenced to the drawings. In the exemplified drawings, for the sake of clearness of the invention, only main contents are expanded and illustrated, and ancillary contents are omitted. Thus, the interpretation of the present invention should not be limited to the drawings.

In the present invention, terms such as first, second, etc. are used to differentiate constitutional elements and have no ordinal meaning or particular meaning.

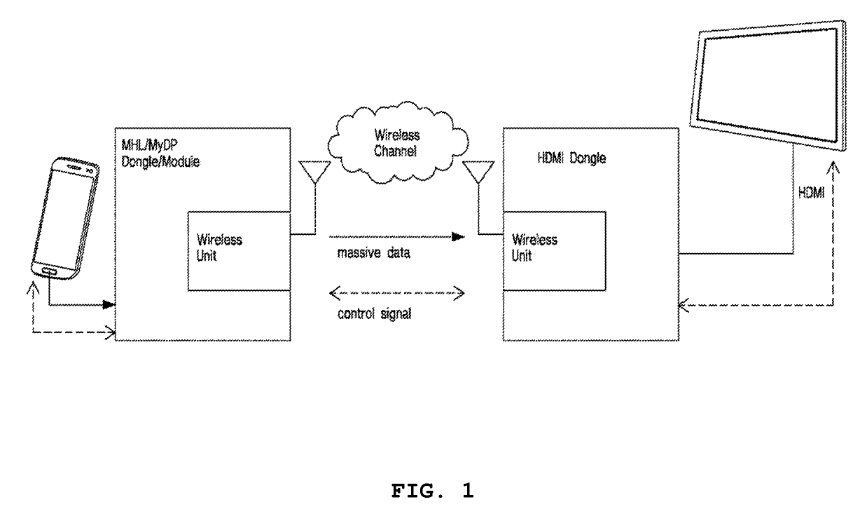

FIG. 1 is a conceptual diagram of a non-protocol wireless interface apparatus according to the present invention. In order to wirelessly transmit data signals from a smart device to a display device at a high-speed, the non-protocol wireless interface apparatus includes a first broadband wireless adapter connected to a wired connection terminal of the smart device, and a second broadband wireless adapter connected to a wired connection terminal of the display device.

The wired connection terminal of the smart device is MHL (mobile high-definition link) port or MyDP (mobility display port) port, and the wired connection terminal of the display device can be HDMI (high-definition multimedia interface) or DP (display port).

The first and second broadband wireless adapters can be in a dongle form by utilizing a gigabit high-speed wireless transmission technology using millimeter wave with the frequency band in the range of 30 to 300 GHz or sub terahertz wave with the frequency band in the range of 100 GHz to 1 THz. In addition, the adapters can be implemented in various forms such as a module form where an RF module is integrated.

An interface which has been jointly developed by AV electronics companies is HDMI, and an interface which has been developed by PC-related companies against HDMI because of the problems such as loyalty is DP. In this regard, an interface connecting to HDMI in a smart mobile device, which has been developed by the HDMI camp, is MHL, and an interface connecting to DP in a smart mobile device, which has been developed by the DP camp, is MyDP. For this reason, compatibility becomes a problem.

The present invention provides a broadband wireless adapter regardless of interface cables which should be provided depending on the interface standard, so makes a connection possible in any interface standard, i.e. either MyDp-to-HDMI or MHL-to-HDMI.

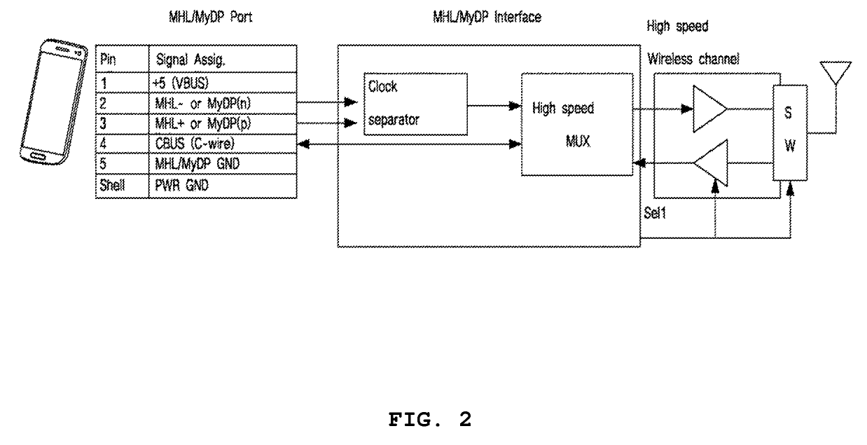

FIG. 2 shows one embodiment for transmitting video and voice data (hereinafter, referred to as “video data”) and control data over a single high-speed wireless channel according to the present invention. The first broadband wireless adapter at the MHL/MyDP port may comprise a clock signal separation unit, a high-speed multiplexer, a first wireless communication unit and a control unit.

The clock signal separation unit removes a common mode clock from the wired connection terminal (MHL/MyDP port) of the smart device. In order to wirelessly transmit a MHL+/MHL- video signal, the common mode clock signal of the MHL port should be separated. The common mode clock signal is removed by connecting MHL+/MHL− signal lines where common mode clock signals are mixed, by means of two resistances, resistance-grounding the MHL+/MHL− signal lines, respectively, and extracting an output between the two resistances.

Meanwhile, since the MyDP(p)/MyDP(n) video signal lines include no common mode clock signal, the signal before passing through the clock signal separation unit and the signal after passing through the unit are the same.

The high-speed multiplexer mixes and multiplexes the video data and the control data in order to transmit the data over a single wireless channel. As the multiplexing scheme, the data can be multiplexed in time division (TDM) or frequency division (FDM).

The first wireless communication unit wirelessly transmits the data multiplexed over the single channel through an antenna. The first wireless communication unit comprises a transmitter/receiver and a switch, and transmits and receives the video data and the control data wirelessly.

When transmitting the video data of the smart mobile device by a selected signal (Sel1) of the control unit through the high-speed multiplexer, the transmitter is enabled, and when receiving the control data from the display device, it is converted into the receiver to input the received control data in CBUS (C-wire) of the MHL/MyDP port.

As such, the present invention has an advantage that since the present invention does not use a transport protocol, there is no need to packetize the data, and accordingly, the data signal can be wirelessly transmitted by uncompressed technique, regardless of interface standards of a smart device.

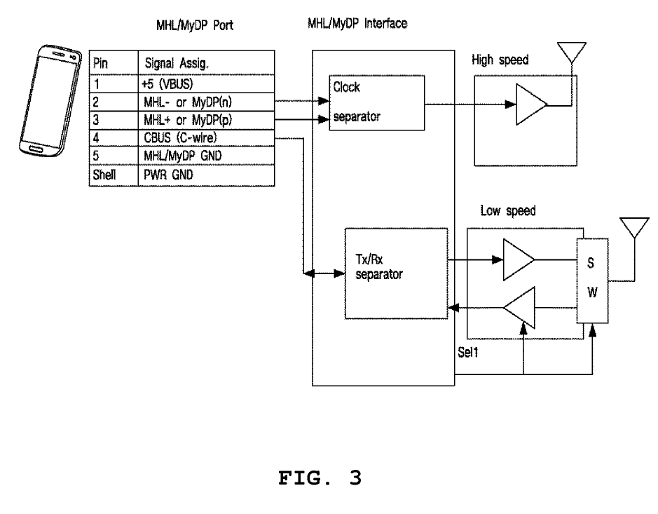

FIG. 3 shows one embodiment for two-channel transmission according to the present invention: transmitting video data over a high-speed wireless channel and transmitting control data over a low-speed wireless channel.

The clock signal separation unit separates the common mode clock in the same manner as the single channel transmission.

The first high-speed wireless communication unit performs only the transmission function of transmitting the video data to the transmitter.

The first low-speed wireless communication unit comprises a transmitter, a receiver and a switch, and serves as transmitting and receiving the control data of CBUS. For the first low-speed communication unit, Bluetooth technology, Zigbee technology, WiFi technology, IrDa technology, etc. can be used.

The two-channel wireless transmission has a disadvantage that a low-speed channel should be provided in addition to a high-speed channel, but has an advantage that a clock data recovery circuitry (CDR) of the receiver, which is necessary for the single-channel high-speed wireless transmission, is unnecessary. In the high-speed wireless transmission, CDR should operate at high-speed, so it consumes lots of power. Thus, while a low-speed channel is further used, the same function can be implemented even with no high-speed circuitry that is heavy to be implemented in a single channel, thereby reducing the power consumption, and it is also possible to implement it at a low price.

The video data is transmitted in one direction from a smart device to a display device, but the control data should be transmitted in two-way between the smart device and the display device.

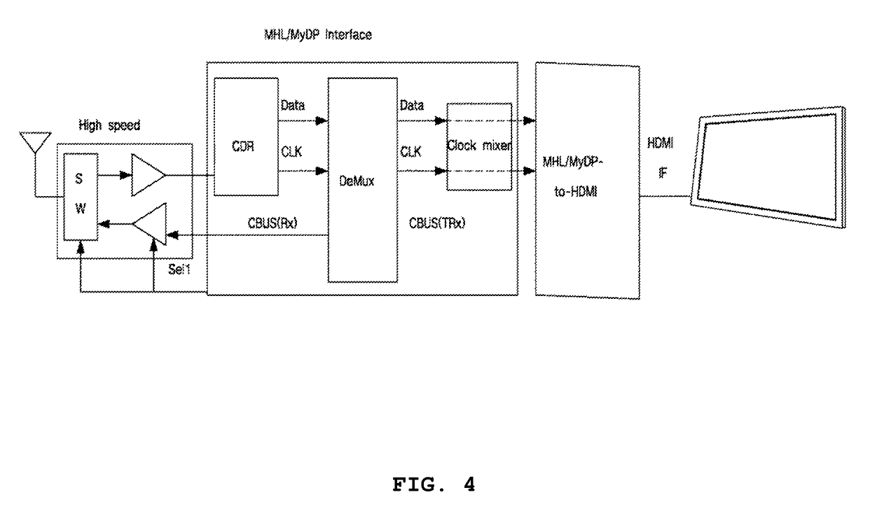

FIG. 4 shows one embodiment for receiving the data wirelessly transmitted over a single channel according to the present invention. The second broadband wireless adapter at the HDMI/DP (hereinafter, referred to as HDMI) port may comprise a second wireless communication unit, a clock data recovery unit (CDR), a high-speed demultiplexer, a clock signal mixing unit, and a control unit.

The second wireless communication unit wirelessly receives data multiplexed over the single channel through an antenna. The second wireless communication unit comprises a transmitter/receiver and a switch, wherein the video data is received by the receiver and the control data transmitted from the display device is transmitted to the first broadband wireless adapter through the transmitter.

The clock data recovery unit recovers the clock and data of the signal received at the second wireless communication unit.

The demultiplexer separates the video data and the control data. The separated video data is transmitted to the clock signal mixing unit, and the control data is connected to CBUS and utilized as a control signal.

The clock signal mixing unit mixes the separated video data with a clock signal and transmits it to the HDMI port. In the case of MyDP signals, since the video signal includes no common mode clock signal, the signal is directly transmitted to the HDMI port without going through the clock signal mixing unit.

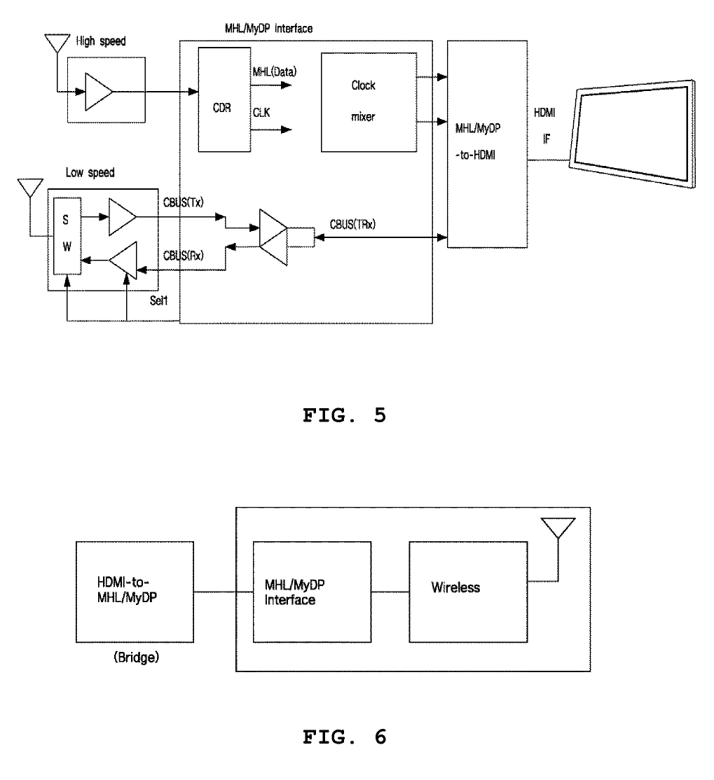

FIG. 5 shows one embodiment for two-channel reception according to the present invention: receiving video data over a high-speed wireless channel and receiving control data over a low-speed wireless channel.

The second high-speed wireless communication unit performs only the receiving function of receiving the video data by the receiver.

The second low-speed wireless communication unit comprises a transmitter, a receiver and a switch, and serves as transmitting/receiving the control data of CBUS. The clock data recovery unit recovers the clock and data of the signal received at the second high-speed communication unit in the same manner as the single-channel receiver.

The clock signal mixing unit mixes the video data recovered at the clock data recovery unit with the clock signal. In the case of MyDP signals, since the video signal includes no common mode clock signal, the signal is directly transmitted to the HDMI port without going through the clock signal mixing unit.

The output port of the smart device can be HDMI or DP, not MHL/MyDP port.

FIG. 6 shows another embodiment according to the present invention, wherein in case where the output port of the smart device is HDMI, a HDMI-to-MHL/MyDP converter is added before the first broadband wireless adapter. Or, if a bridge cable having the HDMI-to-MHL/MyDP converter function is used, the first broadband wireless adapter and the second broadband adapter can be used as they are.

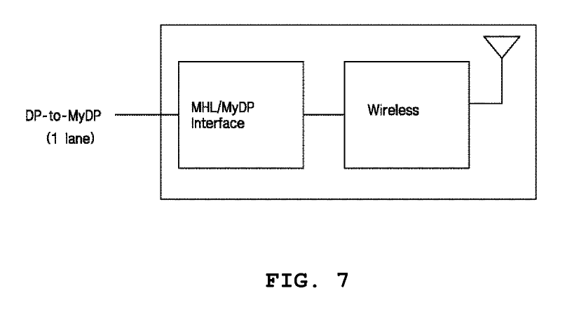

FIG. 7 shows another embodiment according to the present invention. Where the output port of the smart device is DP, the first broadband wireless adapter and the second broadband adapter can be used while standardizing the data of DP as MyDP 1 lane.

According to the a non-protocol wireless interface apparatus, it supports a high-speed wireless communication regarding interface standards between smart devices such as smart phones, smart pads, tablets, digital cameras, and notebooks, and display devices so as to allow a user to view high-quality video of the smart devices on a display having a large screen without any loss of data and image quality.

In addition, there is an effect that the connection between smart device and the display device becomes easy and it is free from restrictions on the distance and positions between the devices owing to the high-speed radio channel connected with the millimeter-wave frequency such as 60 GHz band.

In addition, since non-protocol wireless interface device does not require the complicated settings for the wireless transmission and reception, it may be installed and used simply and does not need the pairing time running to several tens of seconds. Also, since the delay of the signals is not generated, it is transmitted in real time, so that it can be utilized in the game or the automatic driving vehicles.

While the present invention has been described with respect to the specific embodiments, it will be apparent to those skilled in the art that various changes and modifications may be made without departing from the spirit and scope of the invention as defined in the following claims.

What is claimed is:

1. A non-protocol wireless interface apparatus for wirelessly transmitting video data from a smart device to a display device over a single channel, comprising:
a clock signal separation unit for separating a common mode clock signal from a wired connection terminal of the smart device to generate control data;
a multiplexer for mixing and multiplexing the video data and the control data; and
a first wireless communication unit for wirelessly transmitting the multiplexed data over the single channel,
wherein the data signal is wirelessly transmitted over the single channel by uncompressed technique without using a transport protocol, regardless of the interface standard of the smart device.

2. A non-protocol wireless interface apparatus for wirelessly transmitting video data from a smart device to a display device over two channels, comprising:
a clock signal separation unit for separating a common mode clock signal from a wired connection terminal of the smart device to generate control data;
a first high-speed wireless communication unit for wirelessly transmitting the video data; and
a first low-speed wireless communication unit for wirelessly transmitting the control data,
wherein the data signal is wirelessly transmitted over the two channels by uncompressed technique without using a transport protocol, regardless of the interface standard of the smart device.

3. The non-protocol wireless interface apparatus as claimed in claim 1, wherein the first wireless communication unit converts transmission and reception by means of a switch.

4. The non-protocol wireless interface apparatus as claimed in claim 2, wherein the first low-speed wireless communication unit converts transmission and reception by means of a switch.

5. The non-protocol wireless interface apparatus as claimed in claim 1, wherein the multiplexer multiplexes into time division or frequency division.

6. The non-protocol wireless interface apparatus as claimed in claim 2, wherein the wired connection terminal of the smart device is a MHL port or a MyDP port,

7. The non-protocol wireless interface apparatus as claimed in claim 1, wherein a HDMI-to-MHL/MyDP converter is additionally used, where the wired connection terminal of the smart device is a HDMI port.

8. The non-protocol wireless interface apparatus as claimed in claim 2, wherein it standardizes the data of DP as MyDP 1-lane, where the wired connection terminal of the smart device is a DP port.

9. A non-protocol wireless interface apparatus for wirelessly receiving data signal transmitted from a smart device to a display device over a single channel, comprising:
a second wireless communication unit for wirelessly receiving the data signal over the single channel;
a clock data recovery unit for recovering a clock and a data of the data signal received at the second wireless communication unit;
a demultiplexer for separating a video data and a control data from the received data signal; and
a clock signal mixing unit for mixing the separated video data with a clock signal,
wherein the data signal is wirelessly received over the single channel by uncompressed technique without using a transport protocol, regardless of the interface standard of the smart device.

10. A non-protocol wireless interface apparatus for wirelessly receiving data signal transmitted from a smart device to a display device over two channels, comprising:
a second high-speed wireless communication unit for wirelessly receiving a video data;
a second low-speed wireless communication unit for wirelessly receiving a control data;
a clock data recovery unit for recovering a clock and a data of the signal received at the second high-speed communication unit; and
a clock signal mixing unit for mixing the video data recovered at the clock data recovery unit with a clock signal,
wherein the data signal is wirelessly received over the two channels by uncompressed technique without using a transport protocol, regardless of the interface standard of the smart device.

11. The non-protocol wireless interface apparatus as claimed in claims 9, wherein the wired connection terminal of the display device is a HDMI port or a DP port,

12. The non-protocol wireless interface apparatus as claimed in claim 9, wherein the second wireless communication unit converts transmission and reception by means of a switch.

13. The non-protocol wireless interface apparatus as claimed in claim 10, wherein the second low-speed wireless communication unit converts transmission and reception by means of a switch.

14. A non-protocol wireless interface apparatus for combining the interface apparatus for wirelessly transmitting over the single channel, comprising:
a clock signal separation unit for separating a common mode clock signal from a wired connection terminal of the smart device to generate control data;
a multiplexer for mixing and multiplexing the video data and the control data;
a first wireless communication unit for wirelessly transmitting the multiplexed data over the single channel;
a second wireless communication unit for wirelessly receiving the data signal over the single channel;
a clock data recovery unit for recovering a clock and a data of the data signal received at the second wireless communication unit;
a demultiplexer for separating a video data and a control data from the received data signal; and
a clock signal mixing unit for mixing the separated video data with a clock signal,
wherein the data signal is wirelessly transmitted and received over the single channel by uncompressed technique without using a transport protocol, regardless of the interface standard of the smart device.

15. A non-protocol wireless interface apparatus for combining the interface apparatus for wirelessly transmitting over the two channels, comprising:
a clock signal separation unit for separating a common mode clock signal from a wired connection terminal of the smart device to generate control data;
a first high-speed wireless communication unit for wirelessly transmitting the video data;
a first low-speed wireless communication unit for wirelessly transmitting the control data;
a second high-speed wireless communication unit for wirelessly receiving a video data;. a second low-speed wireless communication unit for wirelessly receiving a control data;
a clock data recovery unit for recovering a clock and a data of the signal received at the second high-speed communication unit; and
a clock signal mixing unit for mixing the video data recovered at the clock data recovery unit with a clock signal,
wherein the data signal is wirelessly transmitted and received over the two channels by uncompressed technique without using a transport protocol, regardless of the interface standard of the smart device.
